(19) United States
(12) Patent Application Publication
(10) Pub. No.: US 2010/0098954 A1
(43) Pub. Date: Apr. 22, 2010

(54) OPTICAL ELEMENT AND OPTICAL ELEMENT MANUFACTURING METHOD

(75) Inventors: Takenori SAWAI, Fujimi (JP); Kenji OTSUKA, Suwa (JP); Yasuhide MATSUO, Matsumoto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/578,081

(22) Filed: Oct. 13, 2009

(30) Foreign Application Priority Data
Oct. 22, 2008 (JP) 2008-272468

(51) Int. Cl. B32B 17/06; B32B 37/02; B32B 9/04

(52) U.S. Cl. 428/429; 156/106; 428/447

(57) ABSTRACT

An optical element includes: first and second optical components, at least one of the first and second optical components having a light transmission characteristic; and a bonding film bonding the first and the second optical components together, the bonding film being formed by plasma polymerization and including an Si skeleton having a random atomic structure including a siloxane (Si—O) bond and a leaving group binding to the Si skeleton. The first and second optical components are bonded together by the adhesive properties of the bonding film which are provided by applying energy to at least a part of the bonding film to eliminate the leaving group from the Si skeleton at a surface of the bonding film. Preferably, an average thickness of the bonding film is equal to or less than a wavelength of light passing through the optical component having the light transmission characteristic.

The entire disclosure of Japanese Patent Application No. 2008-272468, filed Oct. 22, 2008 is expressly incorporated by reference herein.

### BACKGROUND

1. Technical Field

The present invention relates to an optical element and an optical element manufacturing method.

2. Related Art

In order to bond two members (substrates) together, a method using an epoxy adhesive, a urethane adhesive, a silicone adhesive, or the like has been typically used. Such adhesives exhibit adhesiveness regardless of the materials of the members. For this reason, members made of various materials can be bonded together in various combinations.

For example, a wave plate is an optical element for causing light passing therethrough to undergo a phase difference. A wave plate is formed by stacking two substrates made of a birefringent crystal, such as quartz crystal, and bonding the substrates together using an adhesive.

In order to bond substrates together using an adhesive as described above, a liquid or paste adhesive is applied to the bonding surfaces of the substrates, and the substrates are stacked with the applied adhesive therebetween. Subsequently, the adhesive is cured with heat or light and thus the substrates are bonded together.

However, there has been a concern that, as for the above-mentioned adhesives, a resin component thereof may degrade over time due to light exposure and thus discoloration, a change in refractive index, a reduction in adhesiveness or the like may occur.

Typically, a layer of an applied adhesive has a thickness of several micrometers or so. It is difficult to make the adhesive layer thinner in terms of the manufacturing method.

For this reason, if a problem as described above occurs in the adhesive layer, the adhesive layer exerts an optically non-negligible influence upon light passing through the wave plate. This results in the deterioration of the optical characteristics of the wave plate.

For example, JP-A-05-270870 discloses laminated glass having a sandwich structure obtained by bonding glass substrates together with an intermediate film made of a polyurethane resin having a thickness of 0.1 to 2 mm or so interposed therebetween. In this laminated glass, the intermediate film may degrade over time and thus the light transmission characteristic thereof may deteriorate.

### SUMMARY

An optical element is provided that is formed by bonding two substrates together with a bonding film therebetween. The optical element has high resistance to light deterioration, high dimensional accuracy, and high light-transmittance. An optical element manufacturing method that allows for easy manufacturing of such optical elements is also provided.

An optical element according to a first aspect includes: first and second optical components, at least one of the first and second optical components having a light transmission characteristic; and a bonding film bonding together the first and the second optical components, the bonding film being formed by plasma polymerization and including an Si skeleton having a random atomic structure including a siloxane (Si—O) bond and a leaving group binding to the Si skeleton. In the element, the first and the second optical components are bonded together by the bonding film having adhesive properties provided by applying energy to at least a part of the bonding film to eliminate the leaving group from the Si skeleton on a surface of the bonding film, and an average thickness of the bonding film is equal to or less than a wavelength of light passing through the optical component having the light transmission characteristic. Thus, there is obtained an optical element that is formed by bonding two optical components together with a bonding film therebetween and has high light resistance and dimensional accuracy as well as a high light transmittance.

Preferably, in the optical element of the aspect, in all atoms except for H atoms included in the bonding film, a sum of a content of Si atoms and a content of O atoms ranges from 10 to 90 atom percent.

Thereby, in the bonding film, the Si atoms and the O atoms form a strong network, so that the bonding film in itself can be made strong. In addition, the bonding film thus formed exhibits particularly high bonding strength against the first and the second optical components.

Preferably, in the optical element of the aspect, a ratio of the Si atoms and the O atoms in the bonding film ranges from 3:7 to 7:3.

Thereby, the stability of the bonding film can be increased, so that the first and the second optical components can be more strongly bonded together.

Preferably, in the optical element of the aspect, a degree of crystallization of the Si skeleton is equal to or less than 45 percent.

Thereby, the Si skeleton can include a particularly random atomic structure, whereby the bonding film obtained can have high size precision and high adhesion properties.

Preferably, in the optical element of the aspect, the bonding film includes an Si—H bond.

The Si—H bond seems to inhibit regular generation of the siloxane bond, so that the siloxane bond is formed in a manner avoiding the Si—H bond, thus reducing a structural regularity of the Si-skeleton. Accordingly, in the plasma polymerization, since the Si—H bond is included in the bonding film, the Si skeleton having a low degree of crystallization can be efficiently formed.

Preferably, in the optical element, when a peak intensity of the siloxane bond is set to 1 in an infrared absorption spectrum of the bonding film including the Si—H bond, a peak intensity of the Si—H bond ranges from 0.001 to 0.2.

Thereby, the atomic structure in the bonding film becomes relatively most random. Accordingly, the bonding film becomes particularly excellent in bonding strength, chemical resistance, and size precision.

Preferably, in the optical element of the aspect, the leaving group includes at least one of an H atom, a B atom, a C atom, an N atom, an O atom, a P atom, an S atom, a halogen atom, and an atom group in which each of the atoms is arranged so as to bind to the Si skeleton.

The leaving group including at least one of them is relatively excellent in selectivity of binding/leaving by application of energy and thus can be relatively easily and evenly eliminated by application of energy, thereby further improving adhesion properties of the bonding film.

Preferably, in the optical element, the leaving group is an alkyl group.

Thereby, the bonding film obtained is excellent in environmental resistance and chemical resistance.

Preferably, in the optical element, when a peak intensity of the siloxane bond is set to 1 in the infrared absorption spectrum of the bonding film including a methyl group as the leaving group, a peak intensity of the methyl group ranges from 0.05 to 0.45.

Thereby, a content of the methyl group can be selected. This prevents the methyl group from inhibiting the generation of the siloxane bond more than necessary, while allowing the generation of a necessary and sufficient number of active bonds in the bonding film. As a result, the bonding film becomes sufficiently adhesive. In addition, the bonding film obtains sufficient environmental resistance and chemical resistance attributed to the methyl group.

Preferably, in the optical element of the aspect, the bonding film includes an active bond at a portion where the leaving group present at least around the surface of the bonding film is eliminated from the Si skeleton.

Thereby, the bonding film can be strongly bonded to the second optical component based on chemical bonding.

Preferably, in the optical element, the active bond is a dangling bond or a hydroxyl group.

Thereby, the bonding film can be particularly strongly bonded to the second optical component.

Preferably, in the optical element of the aspect, the bonding film is mainly made of polyorganosiloxan.

Thereby, the bonding film obtained exhibits higher adhesion properties. In addition, the bonding film has high environmental resistance and high chemical resistance. Thus, for example, the bonding film may be useful in bonding between optical components that will be exposed to a chemical agent or the like over a long period of time.

Preferably, in the optical element, the polyorganosiloxane predominantly contains a polymer of octamethyltrisiloxane.

Thereby, the bonding film obtained exhibits particularly excellent adhesion properties.

Preferably, in the optical element, the average thickness of the bonding film is 90% or less of the wavelength of the light passing through the optical component having the light transmission characteristic.

Thereby, the optical element exhibits better optical characteristics.

Preferably, in the optical element of the aspect, the bonding film is a solid having no fluidity.

Thereby, the size precision of the optical element obtained can be particularly higher than in conventional optical elements. Additionally, as compared to the conventional ones, strong bonding between the optical components can be achieved in a short time.

Preferably, in the optical element of the aspect, the refractive index of the bonding film is 1.35 to 1.6.

The range of the refractive index as above is relatively close to a refractive index of quartz crystal or quartz glass, and thus is suitably used in the process of manufacturing an optical element having a structure where an optical path passes through a bonding film.

Preferably, in the optical element of the aspect, the energy application includes at least one of application of an energy ray to the bonding film and exposure of the bonding film to plasma.

Using UV light as the energy allows a wide range to be evenly treated in a short time, whereby elimination of the leaving group can be efficiently performed. Furthermore, LTV light can be produced by a simple device, such as a UV lamp.

Exposing the bonding film to plasma allows the energy to be applied selectively to a portion around the surface of the bonding film. Accordingly, adhesive properties can be generated at the surface of the bonding film, whereas it can be prevented that a composition, a volume and the like in the bonding film are changed.

Preferably, in the optical element of the aspect, the first and the second optical components are made of quartz glass or quartz crystal.

Thus, the differences in refractive index between the first and second optical components and bonding film are reduced and light loss in the obtained optical element is sufficiently restrained. As a result, the optical element exhibits a good light transmission characteristic.

Preferably, in the optical element, the wavelength of the light passing through the optical component having the light transmission characteristic is 300 to 1200 nm.

Since energy provided by light having such a wavelength is not too high, alteration or degradation of the bonding film due to long-time exposure to light is prevented.

Preferably, in the optical element, the bonding film and a bonding film similar to the bonding film are provided in two or more layers between the first and second optical components, and a sum of thicknesses of all the bonding films is equal to or less than the wavelength of the light passing through the optical component having the light transmission characteristic.

Thereby, the first optical component and second optical component are bonded together more strongly.

An optical element manufacturing method according to a second aspect includes: (a) preparing a first optical component and a second optical component, at least one of the first and second optical components having a light transmission characteristic and being adapted to be bonded together via a bonding film to form an optical element and forming the bonding film on a surface of the first optical component by plasma polymerization, the bonding film including an Si skeleton having a random atomic structure including a siloxane (Si—O) bond and a leaving group binding to the Si skeleton; (b) applying energy to the bonding film to eliminate the leaving group from the Si skeleton in the bonding film so as to provide adhesive properties; and (c) bonding together the first and the second optical components via the bonding film to obtain the optical element. In step (a), the bonding film is formed so that an average thickness thereof is equal to or less than a wavelength of light passing through the optical component having the light transmission characteristic.

Thus, an optical element that is formed by bonding two optical components together with a bonding film therebetween and has high light resistance and dimensional accuracy as well as a high light transmittance is easily manufactured.

### BRIEF DESCRIPTION OF THE DRAWINGS

Embodiments of the invention will be described with reference to the accompanying drawings, wherein like reference numerals represent like elements.

FIGS. 1A to 1C are longitudinal sectional views showing a first embodiment of an optical element manufacturing method.

FIGS. 2D and 2E are longitudinal sectional views showing the first embodiment of the optical element manufacturing method.

FIG. 3 is a partial enlarged view showing a state of a bonding film that has yet to receive energy in the optical element manufacturing method.

FIG. 4 is a partial enlarged view showing a state of the bonding film that has received energy in the optical element manufacturing method.

FIG. 5 is a longitudinal sectional view schematically showing a plasma polymerization apparatus for use in the optical element manufacturing method.

FIGS. 6A to 6C are longitudinal sectional views showing a method for manufacturing a bonding film on a first optical component.

FIGS. 7A to 7D are longitudinal sectional views showing a second embodiment of an optical element manufacturing method.

FIG. 8 is a perspective view showing a wave plate (optical element).

### DESCRIPTION OF EXEMPLARY EMBODIMENTS

An optical element and an optical element manufacturing method will now be described in detail on the basis of exemplary embodiments shown in the accompanying drawings.

The optical element includes two optical components (first optical component 2 and second optical component 4) and a bonding film 3 provided between the optical components 2 and 4). The optical element is formed by bonding together the optical components 2 and 4 with the bonding film 3 therebetween.

The bonding film 3 of the optical component is formed using plasma polymerization and includes a Si skeleton including a siloxane (Si—O) bond and having a random atomic structure, and leaving groups bonded to the Si skeleton.

When energy is applied to the bonding film 3, the leaving groups existing in the bonding film 3 are eliminated from the Si skeleton. Due to the elimination of the leaving groups, the area of the bonding film 3 to which the energy has been applied exhibits adhesiveness.

The bonding film 3 having the above-mentioned characteristic can strongly bond the two optical components 2 and 4 together with high dimensional accuracy and efficiently at a low temperature. By using the bonding film 3 as described above, a reliable optical component formed by strongly bonding the first and second optical components together is obtained.

Also, in the optical component, the average thickness of the bonding film 3 is equal to or less than the wavelength of light passing through the optical element. Since the optical influence of the bonding film 3 upon the light passing through the optical element is negligible, light loss or the like due to the bonding film 3 is restrained. Thus, an optical element having good optical characteristics is obtained.

Optical Element Manufacturing Method

### First Embodiment

Next, a first embodiment of the optical element manufacturing method will be described.

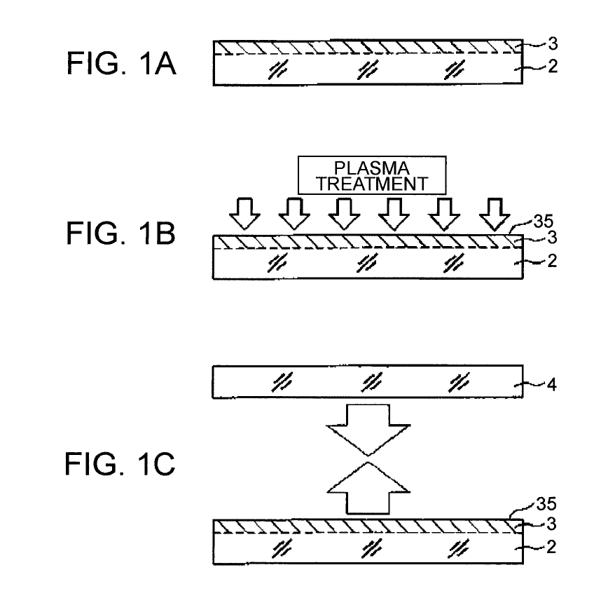

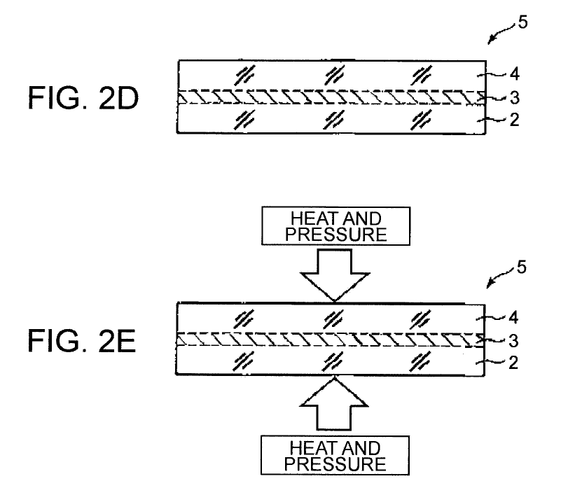

FIGS. 1 to 2 are drawings (longitudinal sectional views) showing the first embodiment of the optical element manufacturing method. In the following description, the upper sides of FIGS. 1 and 2 will be referred to as “upper,” and the lower sides thereof will be referred to as “lower.”

The optical element manufacturing method according to this embodiment includes the step of preparing the first optical component 2 and second optical component 4 and forming the bonding film 3 on a surface of the first optical component 2 using plasma polymerization (first step), the step of applying energy to the bonding film 3 (second step), and the step of bonding the first optical component 2 and second optical component 4 together with the bonding film 3 therebetween so as to obtain a multilayer optical element 5 (third step). The above-mentioned steps will be described in turn below.

1. First, the first optical component 2 and second optical component 4 are prepared.

The first optical component 2 and second optical component 4 are optical components that will form the multilayer optical element 5 having a light transmission characteristic when bonded together with the bonding film 3 therebetween. A specific example of the multilayer optical element 5 will be shown later.

The material of the first optical component 2 may be any material as long as the material is a material having a light transmission characteristic. Among examples of such a material are polyolefins, such as polyethylene, polypropylene, ethylene-propylene copolymer, and ethylene-vinyl acetate copolymer (EVA), cyclic polyolefins, modified polyolefins, polyesters, such as polyvinyl chloride, polyvinylidene chloride, polystyrene, polyamide (for example, nylon 6, nylon 46, nylon 66, nylon 610, nylon 612, nylon 11, nylon 12, nylon 6-12, nylon 6-66), polyimide, polyamidoimide, polycarbonate (PC), poly-(4-methylpentene-1), aionomer, acrylic resin, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyethylene terephthalate (PET), polybutylene terephthalate (PBT), and polycyclohexane terephthalate (PCT), various types of thermoplastic elastomers, such as polyether, polyether ketone (PEK), polyether ether ketone (PEEK), polyether imide, polyacetal (POM), polyphenylene oxide, modified polyphenylene oxide, polysulfone, polyether sulfone, polyphenylene sulfide, polyarylate, aromatic polyester (liquid crystal polymer), polytetrafluoro ethylene, polyvinylidene fluoride, other fluororesins, styrene, polyolefins, polyvinyl chloride, polyurethane, polyester, polyamide, polybutadiene, transpolyisoprene, fluororubber, and polyethylene chloride, various resin materials, such as epoxy resin, phenol resin, urea resin, melamine resin, unsaturated polyester, silicone resin, and urethane resin, copolymers, blends, and polymer alloys mainly containing the above-mentioned resin materials, glass materials, such as soda glass, quartz glass, flint glass, potassium glass, borosilicate glass, and non-alkali glass, and crystalline materials, such as quartz crystal, calcite, sapphire, CaF₂, BaF₂, MgF₂, LiF, KBr, KCl, NaCl, MgO, YVO₄, and LiNbO₃.

Among these materials, a silicon oxide material, such as quartz glass or quartz crystal, is preferably used in terms of the matching between the refractive index of the first optical component 2 and that of the bonding film 3 or the adhesion between the first optical component 2 and bonding film 3. Also, a silicon oxide material has good transparency, as well as has good characteristics such as thermal resistance, light resistance, chemical resistance and mechanical strength. Therefore, it is particularly preferable to use a silicon oxide material as the material of the first optical component 2.

On the other hand, the material of the second optical component 4 is preferably selected from among the materials for the first optical component 2 as appropriate. The material of the first optical component 2 and the material of the second optical component 4 may be identical to each other or different from each other.

Also, the first optical component 2 and second optical component 4 may be components having various optical thin films formed thereon.

Next, as shown in FIG. 1A, the bonding film 3 is formed on a surface of the first optical component 2 (first step). The bonding film 3 is located between the first optical component 2 and second optical component 4 and bonds them together.

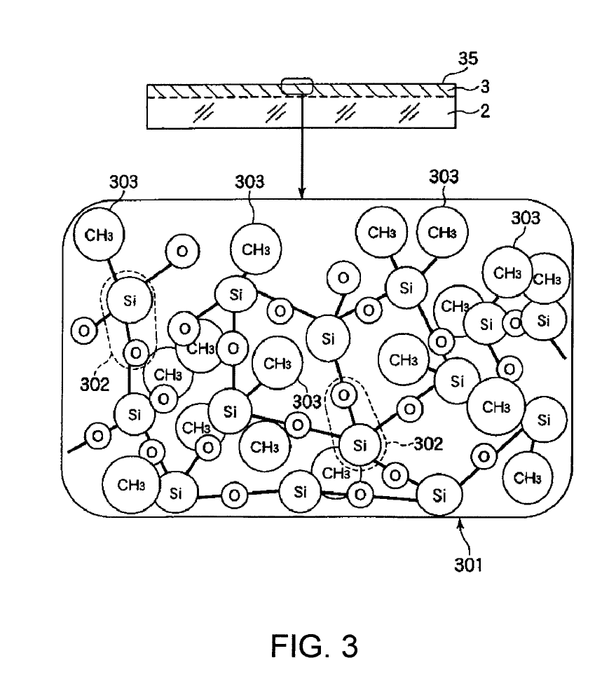

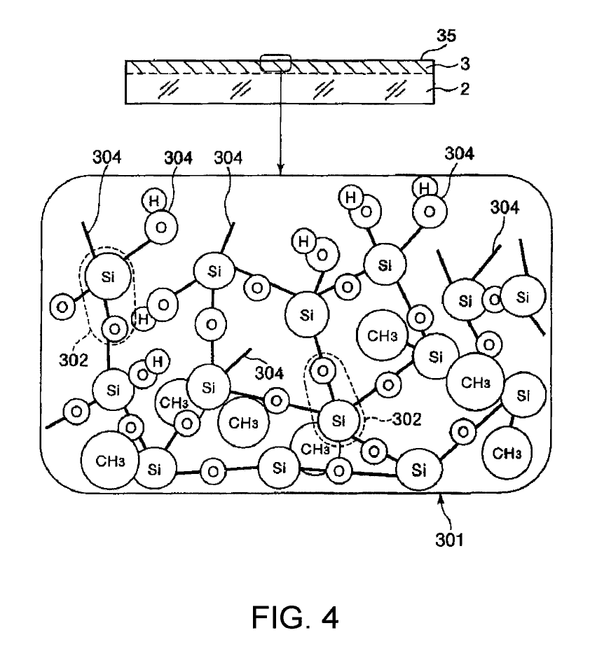

As shown in FIGS. 3 and 4, the bonding film 3 includes a Si skeleton 301 including siloxane (Si—O) bonds 302 and having a random atomic structure, and leaving groups 303 bonded to the Si skeleton 301. The bonding film 3 will be described in detail later.

Also, it is preferable to perform surface treatment for increasing the adhesion between the first optical component 2 and bonding film 3 on at least the area of the first optical component 2 on which the bonding film 3 is to be formed, in accordance with the material of the first optical component 2 before forming the bonding film 3.

Among examples of such surface treatments are physical surface treatments, such as sputtering and blasting, chemical surface treatments, such as plasma treatment using oxygen plasma, nitrogen plasma, or the like, corona discharge, etching, electron beam application, ultraviolet application, and ozone exposure, and combinations thereof. By performing a treatment as described above, the area of the first optical component 2 on which the bonding film 3 is to be formed is cleaned and activated. This increases the bonding strength between the first optical component 2 and bonding film 3.

In particular, use of a plasma treatment among the above-mentioned types of surface treatments makes the surface of the first optical component 2 highly suitable for forming the bonding film 3.

If the first optical component 2 to undergo surface treatment is made of a resin material (polymeric material), corona discharge, nitrogen plasma treatment, or the like is preferably used.

Also, depending on the material of the first optical component 2, there are cases that the bonding strength between the first optical component 2 and bonding film 3 is sufficiently high even if none of the above-mentioned surface treatments is performed. Examples of the material of the first optical component 2 having such an advantage include materials containing any one of various glass materials, crystalline materials, and the like as described above as the main ingredient.

The first optical component 2 made of the above-mentioned material has a surface covered by an oxide film, and relatively active hydroxyl groups are bonded to a surface of the oxide film. Therefore, if the first optical component 2 made of the above-mentioned material is used, the adhesive strength between the first optical component 2 and bonding film 3 is high even if none of the above-mentioned surface treatments is performed.

In this case, the first optical component 2 does not always need to be entirely made of one of the materials described above. It is sufficient if at least the vicinity of the surface area on which the bonding film 3 is to be formed is made of one of the above-mentioned materials.

Similarly, as for the second optical component 4, depending on the material thereof, there are cases that the bonding strength between the first optical component 2 and second optical component 4 is sufficiently high even if none of the above-mentioned surface treatments is performed. As the material of the second optical component 4 having such an advantage, the same materials as those for the first optical component 2 described above, that is, various glass materials, crystalline materials, and the like may be used.

Also, if the second optical component 4 has the following groups or substances on the area thereof to be brought into close contact with the bonding film 3, the bonding strength between the first optical component 2 and second optical component 4 is sufficiently high even if none of the above-mentioned surface treatments is performed.

As such a group or substance, at least one group or substance selected from among a functional group, such as a hydroxyl group, a thiol group, a carboxyl group, an amino group, a nitro group, or an imidazole group, an unsaturated bond, such as a radical, a ring-opening molecule, a double bond, or a triple bond, and a halogen or a peroxide, such as F, Cl, Br, or I can be used.

In order to obtain a surface having such a group or substance thereon, it is preferable to selectively perform the above-mentioned various types of surface treatment as appropriate.

Also, instead of performing a surface treatment, it is preferable to pre-form intermediate layers on at least the area of the first optical component 2 on which the bonding film 3 is to be formed and the area of the second optical component 4 to be brought into close contact with the bonding film 3.

The intermediate layers may have any function. For example, it is preferable to form intermediate layers for increasing the adhesiveness between the first and second optical components and bonding film 3, cushioning (shock absorption), reducing stress concentration, or the like. By using such intermediate layers, a reliable multilayer optical element can be obtained.

Exemplary materials of such intermediate layers include oxide materials, such as a metallic oxide and a silicon oxide, nitride materials, such as a metal nitride and a silicon nitride, carbon materials, such as graphite and diamond-like carbon, self-assembled film materials, such as a silane coupling agent, a thiol compound, a metal alkoxide, and a metal-halogen compound, and resin materials, such as a resin adhesive, a resin film, a resin coating material, various rubber materials, and various elastomers. Also, combinations of two or more of these materials may be used.

By using intermediate layers made of an oxide material among these materials, the bonding strength of the multilayer optical element 5 is particularly increased.

2. Next, as shown in FIG. 1B, energy is applied to the bonding film 3.

At that time, the leaving groups 303 are eliminated from the Si skeleton 301 at the surface of the bonding film 3. After the leaving groups 303 are eliminated, active hands are formed in the bonding film 3. Thus, the bonding film 3 exhibits stable adhesiveness to the second optical component 4. As a result, the bonding film 3 is stably and strongly bonded to the second optical component 4 on the basis of chemical bonds.

As shown in FIG. 3, the bonding film 3, which has yet to receive energy, includes the Si skeleton 301 and leaving groups 303. When energy is applied to the bonding film 3 having such a composition, the leaving groups 303 (in this embodiment, methyl groups), in particular, those in the vicinity of the surface leave the Si skeleton 301. Thus, as shown in FIG. 4, the active hands 304 are formed at a surface 35 of the bonding film 3 so that the bonding film 3 is activated. As a result, the surface of bonding film 3 exhibits adhesiveness.

“The bonding film 3 is activated” refers to: a state where the leaving groups 303 are eliminated from the surface 35 of the bonding film 3 and the interior thereof and unterminated, bonded hands (also referred to as “unbonded hands” or “dangling bonds”) are formed; a state where the unbonded hands are terminated by hydroxyl groups (OH groups); or a state where these states are mixed.

Therefore, the active hands 304 refer to unbonded hands (dangling bonds), or unbonded hands terminated by hydroxyl groups. By using the active hands 304 as described above, the bonding film 3 is strongly bonded to the second optical component 4.

Examples of methods for applying energy to the bonding film 3 include a method of applying energy beams to the bonding film 3 and a method of exposing the bonding film 3 to plasma.

Examples of energy beams that can be applied to the bonding film 3 include beams, such as ultraviolet rays and laser beams, corpuscular rays, such as x rays, gamma rays, electron beams, and ion beams, and combinations of these energy beams.

Among these energy beams, it is preferable to use ultraviolet rays having a wavelength of 126 to 300 nm or so. By using such ultraviolet rays, a desired energy can be applied. The desired energy prevents destruction of the Si skeleton 301 of the bonding film 3 more than necessary, as well as allows selective cleavage of the bonds between the Si skeleton 301 and leaving groups 303. This allows the bonding film 3 to exhibit adhesiveness while preventing degradation of the characteristics (mechanical characteristics, chemical characteristics, and the like) of the bonding film 3.

Also, by using ultraviolet rays, a wide area is treated uniformly within a short time. Thus, the leaving groups 303 are efficiently eliminated. Further, ultraviolet rays have an advantage that ultraviolet rays can be generated using a simple facility, such as a UV lamp.

More preferably, ultraviolet rays having a wavelength of 160 to 200 nm or so are used. If a UV lamp is used, the output thereof is preferably 1 mW/cm² to 1 W/cm² or so, and more preferably, 5 mW/cm² to 50 mW/cm² or so, although it depends on the area of the bonding film 3. In this case, the separation distance between the UV lamp and bonding film 3 is preferably 3 to 3000 nm or so, and more preferably, 10 to 1000 mm or so.

The time during which ultraviolet rays are applied is preferably a time within which the leaving groups 303 in the vicinity of the surface 35 of the bonding film 3 can be eliminated, that is, a time during which many leaving groups 303 are not eliminated from the interior of the bonding film 3. Specifically, the amount of time the ultraviolet rays are applied is preferably 0.5 to 30 minutes or so, and more preferably, 1 to 10 minutes or so, although it varies depending on the material of the bonding film 3, or the like.

While ultraviolet rays may be applied temporally continuously, they may also be applied intermittently (in a pulse manner).

Exemplary laser beams include an excimer laser (femtosecond laser), an Nd-YAG laser, an Ar laser, a CO₂ laser, and a He—Ne laser.

Energy beams may be applied to the bonding film 3 in any type of atmosphere. Specific examples of an atmosphere include oxidizing gas atmospheres, such as air and oxygen, reducing gas atmospheres, such as hydrogen, inert gas atmospheres, such as nitrogen and argon, and reduced-pressure (vacuum) atmospheres obtained by reducing the pressure of these atmospheres. Among these, an inert gas atmosphere or a reduced-pressure atmosphere (vacuum) is preferably used. This prevents the bonding film 3 from being oxidized and thus altered or degraded.

Also, the atmosphere is preferably a dried atmosphere. This prevents the adherence of water vapor contained in the atmosphere to the cleavage traces of chemical bonds cleaved due to application of ultraviolet rays, thereby preventing an unintended change in composition of the bonding film 3.

Specifically, the dew point of the atmosphere is preferably −10° C. or less, and more preferably, −20° C. or less.

Also, by using a method of applying energy beams, the magnitude of energy to be applied can be accurately and easily adjusted. This makes it possible to adjust the number of leaving groups 303 that are to be eliminated from the bonding film 3. As a result, the bonding strength of the multilayer optical element 5 is easily controlled.

That is, if the number of leaving groups 303 that are to be eliminated is increased, more active hands are formed at the surface 35 of the bonding film 3 and inside the bonding film 3. Thus, the adhesiveness of the bonding film 3 is further increased. On the other hand, if the number of the leaving groups 303 that are to be eliminated is reduced, the number of active hands to be formed at the surface 35 of the bonding film 3 and inside the bonding film 3 is reduced. Thus, the adhesiveness of the bonding film 3 is restrained.

In order to adjust the magnitude of energy to be applied, it is preferable to adjust the conditions, such as the type of energy beams, the output of energy beams, and the time during which energy beams are applied.

On the other hand, if the method of exposing the bonding film 3 to plasma is used, energy can be selectively applied to the vicinity of the surface 35 of the bonding film 3. This prevents the leaving groups 303 from being eliminated from the interior of the bonding film 3. This allows the surface 35 of the bonding film 3 to reliably exhibit adhesiveness while preventing changes in the inner composition, volume, and the like of the bonding film 3 due to the elimination of the leaving groups 303 from the interior of the bonding film 3.

In this case, it is preferable to use atmospheric pressure plasma as the plasma to which the bonding film 3 is to be exposed. By using atmospheric pressure plasma, a plasma treatment can be easily performed without having to use a costly facility, such as a pressure reducer. As a method for performing plasma treatment, it is preferable to use a direct plasma method by which a plasma is generated in the vicinity of the bonding film 3. Also, it is preferable to use a remote plasma method or a down flow plasma method by which an object to be treated and a plasma generation unit are separated. By using the direct plasma method, plasma is generated in the vicinity of the bonding film 3. Thus, the plasma treatment is efficiently and uniformly performed. Also, if an object to be treated and a plasma generation unit are separated, the object to be treated and plasma generation unit do not interfere with each other. Thus, the object to be treated does not suffer ion-damage.

Incidentally, if the plasma treatment is performed in a reduced-pressure atmosphere, a gas unintentionally confined inside the bonding film 3, a gas that has occurred with time, or the like may be extracted out of the bonding film 3. Such a phenomenon causes damage to the bonding film 3 and reduces the adhesiveness of the bonding film 3, as well as reduces the optical performance of the bonding film 3.

On the other hand, if the plasma treatment is performed at an atmospheric pressure, the bonding film 3 is prevented from being damaged. As a result, the bonding film 3 has good adhesiveness and optical performance.

Among the gases used to generate the plasma are Ar, He, H₂, N₂, and O₂. Two or more of these substances may be mixed. Considering oxidation or the like of the bonding film 3, an inert gas, such as Ar or He among the above-mentioned gases, is preferably used.

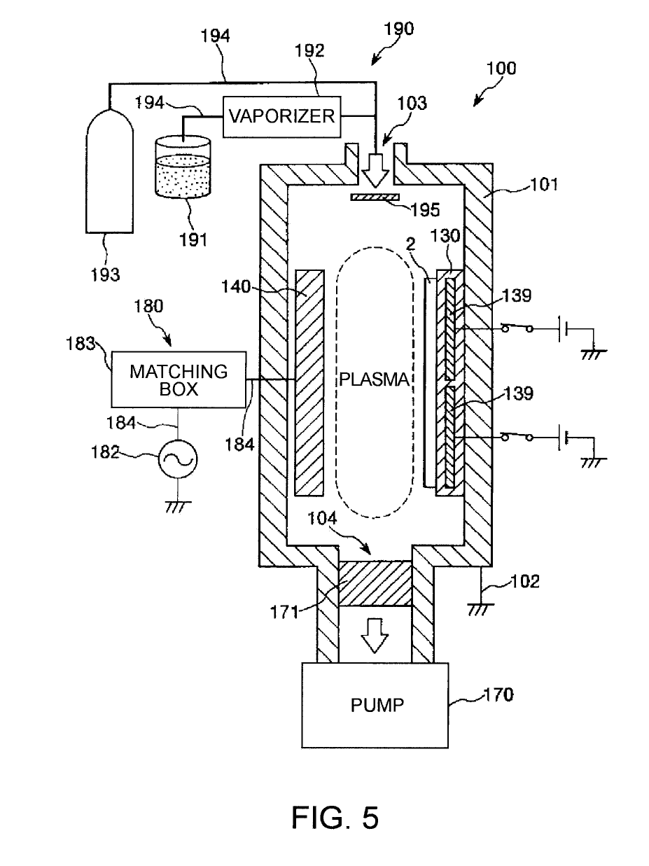

Also, the plasma treatment may be performed using a plasma polymerization apparatus 100 shown in FIG. 5 to be described later. In this case, it is possible to form the bonding film 3 using the plasma polymerization apparatus 100 shown in FIG. 5 and then subject the formed bonding film 3 to the plasma treatment in this step continuously without having to extract the bonding film. This simplifies the optical element manufacturing method according to this embodiment.

Also, the frequency of a voltage to be applied between electrodes in order to generate plasma using discharge is preferably a high frequency of one MHz or more. Thus, the discharge start voltage is lower than that in a case where direct-current discharge is performed. Thus, the discharge state is easily maintained. Also, by using a high frequency voltage, the ionization degree in the plasma is increased and the plasma density is increased. Thus, the plasma efficiently causes the leaving groups 303 to be eliminated.

The frequency of a voltage to be applied between the electrodes is not particularly limited and is preferably 10 to 50 MHz or so, and more preferably, 10 to 40 MHz or so.

Also, methods for applying the energy in step 2. include not only the above-mentioned methods but also heating, pressurization, and exposure to ozone.

As shown in FIG. 3, the bonding film 3 that has yet to receive energy includes the Si skeleton 301 and leaving groups 303. When energy is applied to the bonding film 3 having such a composition, the leaving groups 303 (in this embodiment, methyl groups) are eliminated from the Si skeleton 301. Thus, as shown in FIG. 4, the active hands 304 are formed at the surface 35 of the bonding film 3 so that the bonding film 3 is activated. As a result, the surface of the bonding film 3 exhibits adhesiveness.

“The bonding film 3 is activated” refers to a state where the leaving groups 303 are eliminated from an area near and along the surface 35 of the bonding film 3 or the interior of the bonding film 3 and unterminated, bonded hands (also referred to as “unbonded hands” or “dangling bonds”) are formed in the Si skeleton 301, a state where the unbonded hands are terminated by hydroxyl groups (OH groups), or a state where these states are mixed.

Therefore, the active hands 304 refer to unbonded hands (dangling bonds), or unbonded hands terminated by hydroxyl groups. By using the active hands 304 as described above, the first optical component 2 and second optical component 4 are bonded together more strongly with the bonding film 3 therebetween.

3. Next, as shown in FIG. 1C, the first optical component 2 and second optical component 4 are bonded together in such a manner that the activated bonding film 3 and second optical component 4 are brought into close contact with each other. Thus, the multilayer optical element 5 as shown in FIG. 2D is obtained (third step).

In the multilayer optical element 5 obtained in the above-mentioned way, the optical components are bonded together on the basis of firm chemical bonds formed within a short time, such as covalent bonds, rather than on the basis of physical bonds due to an anchor effect obtained when using an adhesive in the related-art optical element manufacturing method. Thus, the multilayer optical element 5 is formed within a short time. Also, the multilayer optical element 5 is very resistant to peeling-off and is less likely to cause bonding unevenness.

Also, the above-mentioned method does not require thermal treatment under high temperature (for example, 700° C. or higher) unlike the related-art solid-state bonding, so the first optical component 2 and second optical component 4 made of a less heat resistant material can be also bonded together.

Also, the first optical component 2 and second optical component 4 are bonded together with the bonding film 3 therebetween. This is also advantageous in that the materials of the first optical component 2 and second optical component 4 are not particularly limited.

As seen, adoption of this embodiment can increase the choices of the materials of the first optical component 2 and second optical component 4.

Also, in this embodiment, the bonding film 3 is provided on only one (in this embodiment, the first optical component 2) of the first optical component 2 and second optical component 4 to be bonded together. When forming the bonding film 3 on the first optical component 2, the first optical component 2 may be subjected to plasma over a relatively long time depending on the method for manufacturing the bonding film 3. On the other hand, in this embodiment, the second optical component 4 is not subjected to plasma. Therefore, for example, even if the second optical component 4 has extremely low resistance to plasma, the first optical component 2 and second optical component 4 can be strongly bonded together by using the method according to this embodiment. This is also advantageous in that the material of the second optical component 4 can be selected from among a wide range of materials without having to strongly consider its resistance to plasma.

Hereafter, a mechanism where the first optical component 2 and second optical component 4 are bonded together in this step will be described.

As an example, a case where hydroxyl groups are exposed at the bonding surface of the second optical component 4 will be described. When bonding the first optical component 2 and second optical component 4 together in this step in such a manner that the surface 35 of the bonding film 3 and the bonding surface of the second optical component 4 are brought into contact with each other, hydroxyl groups existing at the surface 35 of the bonding film 3 and hydroxyl groups existing at the bonding surface of the second optical component 4 attract each other due to hydrogen bonds. Thus, attractive forces occur between these hydroxyl groups. These attractive forces bond the first optical component 2 and second optical component 4 together.

Also, the hydroxyl groups attracting each other due to the hydrogen bonds are dehydrated and condensed depending on conditions, such as temperature. As a result, at the contact interface between the first optical component 2 and second optical component 4, bonded hands to which the hydroxyl groups are bonded are bonded to each other with an oxygen atom therebetween. The first optical component 2 and second optical component 4 are bonded together more strongly due to the bonds between the bonded hands.

Incidentally, the active state of the surface of the bonding film 3 activated in the previous step 2 relaxes with time. For this reason, it is preferable to perform the present step 3 as soon as possible after the previous step 2. Specifically, after the previous step 2, the present step 3 is preferably performed within 60 minutes, and more preferably, within 5 minutes. Within such a time, the surface of the bonding film 3 is kept in a sufficiently active state. Therefore, when bonding the first optical component 2 and second optical component 4 together in the present step, sufficient bonding strength can be obtained between these optical components.

In other words, the bonding film 3 that has yet to be activated is chemically relatively stable and has good environmental resistance, since the bonding film 3 is a bonding film having the Si skeleton 301. For this reason, the bonding film 3 that has yet to be activated is suitable for long-time conservation. Therefore, it is effective in terms of the manufacturing efficiency of the multilayer optical element 5 to pre-manufacture or purchase many first optical components 2 each provided with the yet-to-be-activated bonding film 3 and conserve them, and apply energy to only a required number of the conserved first optical components 2 in the way described in the previous step 2 immediately before performing bonding in the present step.

In the above-mentioned way, the multilayer optical element (optical element according to this embodiment) 5 shown in FIG. 2D is obtained.

While the second optical component 4 is overlaid on the bonding film 3 in FIG. 2D in such a manner that the second optical component 4 covers the entire surface of the bonding film 3, the relative positions of the second optical component 4 and bonding film 3 may be displaced from each other. That is, the second optical component 4 may extend off the bonding film 3.

In the multilayer optical element 5 obtained in the above-mentioned way, the bonding strength between the first optical component 2 and second optical component 4 is preferably 5 MPa (50 kgf/cm²) or more, and more preferably, 10 MPa (100 kgf/cm²). The multilayer optical element 5 having such bonding strength sufficiently prevents itself from being peeled off.

The obtained bonding film 3 has a refractive index of 1.35 to 1.6 or so. The above-mentioned refractive index of the bonding film 3 is close to those of quartz crystal and quartz glass, so the bonding film 3 is preferably used in the process of bonding together optical components containing quartz crystal or quartz glass as the main ingredient.

Also, the thermal expansion coefficient of the bonding film 3 is close to those of quartz crystal and quartz glass, so the differences in thermal expansion coefficient between the optical components and the bonding film 3 are small. Thus, deformation of the multilayer optical element 5 after bonding is restrained.

After obtaining the multilayer optical element 5, at least one (step of increasing the bonding strength of the multilayer optical element 5) of the following two steps (4A and 4B) may be performed on the multilayer optical element 5 if desired. If performed, the bonding strength of the multilayer optical element 5 is further increased.

4A As shown in FIG. 2E, pressure is applied to the obtained multilayer optical element 5 in directions in which the first optical component 2 and second optical component 4 are brought close to each other.

Thus, the surfaces of the bonding film 3 are brought closer to the surfaces of the first optical component 2 and second optical component 4, thereby further increasing the bonding strength of the multilayer optical element 5.

Also, by applying pressure to the multilayer optical element 5, gaps remaining on the bonding interfaces inside the multilayer optical element 5 are crushed so that the bonding area is further increased. Thus, the bonding strength of the multilayer optical element 5 is further increased.

In this case, pressure to be applied to the multilayer optical element 5 is preferably as high as possible without damaging the multilayer optical element 5. Thus, the bonding strength of the multilayer optical element 5 is increased in proportion to the applied pressure.

This pressure is preferably adjusted as appropriate in accordance with the conditions, such as the materials or thicknesses of the first optical component 2 and second optical component 4 and the bonding apparatus. Specifically, the pressure is preferably 0.2 to 10 MPa or so, and more preferably, 1 to 5 MPa or so, although it slightly varies depending on the materials or thicknesses of the first optical component 2, the second optical component 4, or the like. Thus, the bonding strength of the multilayer optical element 5 is reliably increased. While the pressure may exceed the above-mentioned upper limit, the first optical component 2 and second optical component 4 may be damaged depending on the materials of these optical components.

While the time during which pressure is applied to the multilayer optical element 5 is not particularly limited, it is preferably 10 seconds to 30 minutes or so. The time during which pressure is applied is preferably changed as appropriate in accordance with the magnitude of the pressure. Specifically, if higher pressure is applied to the multilayer optical element 5, the bonding strength is increased even if the pressure application time is reduced.

4B As shown in FIG. 2E, heat is applied to the obtained multilayer optical element 5.

Thus, the bonding strength of the multilayer optical element 5 is further increased.

In this case, the temperature of the heat to be applied to the multilayer optical element 5 is not particularly limited as long as the temperature is higher than the room temperature and lower than the heat-resistant temperature of the multilayer optical element 5. The temperature is preferably 25 to 100° C., and more preferably, 50 to 100° C. If heat within such a range is applied to the multilayer optical element 5, alteration or degradation of the multilayer optical element 5 is reliably prevented and the bonding strength is reliably increased.

While the heating time is not particularly limited, it is preferably 1 to 30 minutes or so.

If both the steps 4A and 4B are performed, these steps are preferably simultaneously performed. This is, as shown in FIG. 2E, it is preferable to apply heat to the multilayer optical element 5 while simultaneously applying pressure thereto. Thus, a pressurization effect and a heating effect are exhibited synergistically so that the bonding strength of the multilayer optical element 5 is further increased.

By performing the above-mentioned steps, the bonding strength of the multilayer optical element 5 is easily further increased.

Hereafter, the bonding film 3 will be described in detail.

As described above, the bonding film 3 is formed using plasma polymerization. As shown in FIG. 3, the bonding film 3 includes the Si skeleton 301 including siloxane (Si—O) bonds 302 and having a random atomic structure, and the leaving groups 303 bonded to the Si skeleton 301. The bonding film 3 having the above-mentioned composition is resistant to deformation and strong due to the Si skeleton 301 including the siloxane bonds 302 and having a random atomic structure. Conceivably, this is because the Si skeleton 301 has a low degree of crystallization and thus does not easily cause a defect, such as dislocation, on the grain boundary. This increases the bonding strength, chemical resistance, light damage resistance, and dimensional accuracy of the bonding film 3, thereby increasing these characteristics of the multilayer optical element 5 finally obtained.

When energy is applied to the above-mentioned bonding film 3, the leaving groups 303 are eliminated from the Si skeleton 301 and, as shown in FIG. 4, the active hands 304 are formed at the surface 35 of the bonding film 3 and inside the bonding film 3. As a result, the surface of the bonding film 3 exhibits adhesiveness. The exhibited adhesiveness strongly and efficiently bonds the bonding film 3 to the second optical component 4 with high dimensional accuracy.

The bond energy between each leaving group 303 and Si skeleton 301 is smaller than the bond energy of each siloxane bond 302 inside the Si skeleton 301. Thus, when receiving energy, the bonding film 3 selectively cleaves the bonds between the leaving groups 303 and Si skeleton 301 so that the leaving groups 303 are eliminated while preventing destruction of the Si skeleton 301.

Also, the bonding film 3 is a solid-state film that does not have fluidity. Therefore, the thickness or shape of the bonding layer (bonding film 3) hardly varies unlike the related-art, since liquid or mucus-like adhesive have fluidity. This makes the dimensional accuracy of the multilayer optical element 5 much higher than that of the related-art multilayer optical element. Also, since the long time required to cure the adhesive becomes unnecessary, a strong bond is made within a short time.

Among all the atoms contained in the bonding film 3 except for H atoms, the sum of the percentage of Si atoms and that of O atoms is preferably 10 to 90 atom %, and more preferably, 20 to 80 atom %. If the Si atoms and O atoms are contained in a percentage within the above-mentioned range, the Si atoms and O atoms form a strong network in the bonding film 3. This strengthens the bonding film 3 itself. The bonding film 3 having the above-mentioned composition exhibits particularly high bonding strength to the first optical component 2 and second optical component 4.

The abundance ratio between the Si atoms and O atoms is preferably 3:7 to 7:3 or so, and more preferably, 4:6 to 6:4 or so. By setting the abundance ratio between the Si atoms and O atoms within the above-mentioned range, the stability of the bonding film 3 is increased. Thus, the first optical component 2 and second optical component 4 are more strongly bonded together.

The degree of crystallization of the Si skeleton 301 included in the bonding film 3 is preferably 45% or less, and more preferably, 40% or less. This makes the atomic structure of the Si skeleton 301 sufficiently random. As a result, the above-mentioned characteristics of the Si skeleton 301 manifest themselves, and the dimensional accuracy and adhesiveness of the bonding film 3 is increased.

The degree of crystallization of the Si skeleton 301 can be measured using a typical degree of crystallization measuring method. Among such degree of crystallization measuring methods are a method of measuring the degree of crystallization on the basis of the strength of scattered X rays on a crystalline portion (x ray method), a method of obtaining the degree of crystallization from the strength of a crystallization band that absorbs infrared rays (infrared ray method), a method of obtaining the degree of crystallization on the basis of the area below a differential curve that absorbs nuclear magnetic resonance (nuclear magnetic resonance method), and a chemical method using the fact that it is difficult to make a chemical reagent penetrate a crystalline portion.

The bonding film 3 preferably includes Si—H bonds in the structure thereof. The Si—H bonds are formed in polymers when silane makes polymerization reactions due to plasma polymerization. At that time, the Si—H bonds prevent siloxane bonds from being formed regularly. For this reason, siloxane bonds are formed in such a manner that the siloxane bonds avoid the Si—H bonds. Thus, the regularity of the atomic structure of the Si skeleton 301 is reduced. Therefore, by using plasma polymerization, the Si skeleton 301 with a low degree of crystallization is efficiently formed.

On the other hand, it cannot be said that as the percentage of Si—H bond content of the bonding film 3 is increased, the degree of crystallization is reduced. Specifically, assuming that the peak intensity of a siloxane bond is 1 in an infrared absorption spectrum of the bonding film 3, the peak intensity of a Si—H bond is preferably 0.001 to 0.2 or so, more preferably, 0.002 to 0.05 or so, and even more preferably, 0.005 to 0.02 or so. If the ratio of the Si—H bonds to the siloxane bonds falls within the above-mentioned range, the atomic structure of the bonding film 3 becomes the most random. Therefore, if the peak intensity of a Si—H bond relative to that of a siloxane bond falls within the above-mentioned range, the bonding film 3 exhibits particularly good bonding strength, chemical resistance, and dimensional accuracy.

As described above, when the leaving groups 303 bonded to the Si skeleton 301 are eliminated from the Si skeleton 301, the active hands are formed in the bonding film 3. Therefore, the leaving groups 303, which are eliminated relatively easily and uniformly when receiving energy, must be reliably bonded to the Si skeleton 301 so as not to be eliminated when receiving no energy.

When making a film using plasma polymerization, the contents of a source gas are polymerized so that the Si skeleton 301 including siloxane bonds and residues bonded to the Si skeleton 301 are formed. For example, these residues can become the leaving groups 303.

In view of the foregoing, as the leaving groups 303, at least one atom selected from among an H atom, a B atom, a C atom, an N atom, an O atom, a P atom, an S atom, and a halogen atom or at least one group selected from an atomic group that include these atoms and where these atoms are disposed as bonded to the Si skeleton 301 is preferably used. The leaving groups 303 having the above-mentioned composition show relatively good selectivity between bonding and elimination when receiving energy. For this reason, the leaving groups 303 sufficiently meet the above-mentioned needs. Thus, the adhesiveness of the bonding film 3 is further increased.

Among examples of the above-mentioned atomic groups where atoms are disposed as bonded to the Si skeleton 301 are alkyl groups, such as a methyl group and an ethyl group, alkenyl groups, such as a vinyl group and an allyl group, an aldehyde group, a ketone group, a carboxyl group, an amid group, a nitro group, a halogen alkyl group, a mercapto group, a sulfonic acid group, a cyano group, and an isocyanate group.

Among these types of groups, alkyl groups are preferably used as the leaving groups 303. Since alkyl groups have high chemical stability, the bonding film 3 including alkyl groups exhibits good environmental resistance and chemical resistance.

If methyl groups (—CH₃) are used as the leaving groups 303, the preferable percentage of methyl group content is defined as follows on the basis of the peak intensity in an infrared absorption spectrum.

Specifically, assuming that the peak intensity of a siloxane bond is 1 in an infrared absorption spectrum of the bonding film 3, the peak intensity of a methyl group is preferably 0.05 to 0.45 or so, more preferably, 0.1 to 0.4 or so, and even more preferably, 0.2 to 0.3 or so. If the ratio of the peak intensity of a methyl group to that of a siloxane bond falls within the above-mentioned range, the methyl groups are prevented from hampering formation of siloxane bonds more than necessary, and a necessary and sufficient number of active hands are formed inside the bonding film 3. Thus, the bonding film 3 exhibits sufficient adhesiveness. Also, the bonding film 3 exhibits sufficient environmental resistance and chemical resistance attributable to the methyl groups.

Among examples of the material of the bonding film 3 having the above-mentioned characteristics is a polymer including siloxane bonds, such as polyorganosiloxane, and organic groups that are bonded to the siloxane bonds and can become the leaving groups 303.

If the bonding film 3 is made of a polyorganosiloxane, the bonding film 3 itself has good mechanical characteristics. Also, the bonding film 3 exhibits good adhesiveness to various types of materials. Therefore, the bonding film 3 made of a polyorganosiloxane adheres to the first optical component 2 particularly strongly and exhibits particularly strong adherence to the second optical component 4. As a result, the first optical component 2 and second optical component 4 are strongly bonded together.

Generally, a polyorganosiloxane is water-repellent (non-adhesive). However, when receiving energy, a polyorganosiloxane easily causes organic groups to be eliminated and thus becomes hydrophilic and exhibits adhesiveness. Therefore, a polyorganosiloxane has an advantage that the non-adhesiveness and adhesiveness thereof can be easily and reliably controlled.

Such water-repellency (non-adhesiveness) is primarily an effect of alkyl groups contained in a polyorganosiloxane. Therefore, the bonding film 3 made of a polyorganosiloxane has an advantage that it exhibits adhesiveness at the surface 35 when receiving energy, as well as an advantage that the above-mentioned effect of alkyl groups is obtained on the portion thereof other than the surface 35. Therefore, the above-mentioned bonding film 3 exhibits good environmental resistance and chemical resistance and is effectively used, for example, in the process of assembling optical components to be exposed to chemicals or the like for a long period of time.

Among polyorganosiloxanes, a polyorganosiloxane containing a polymer formed of an octamethyltrisiloxane as the main ingredient is preferably used. The bonding film 3 containing a polymer formed of an octamethyltrisiloxane as the main ingredient exhibits particularly good adhesiveness. A material containing an octamethyltrisiloxane as the main ingredient is liquid at the room temperature and has appropriate viscosity, so the material has an advantage that it is easily handled.

As described above, the average thickness of the bonding film 3 is equal to or less than the wavelength of light passing through the multilayer optical element 5. Therefore, in the multilayer optical element 5, the optical influence of the bonding film 3 upon the passing light is almost negligible. Specifically, discoloration of the bonding film 3 or differences in refractive index between the optical components 2 and 4 and bonding film 3 is prevented from affecting light passing through the multilayer optical element 5. As a result, light loss or the like caused by the bonding film 3 is restrained and the multilayer optical element 5 exhibits good optical characteristics.

Specifically, the average thickness of the bonding film 3 is preferably 90% or less of the wavelength of light passing through the multilayer optical element 5, and more preferably, 80% or less thereof. By setting the average thickness of the bonding film 3 within the above-mentioned range, the multilayer optical element 5 exhibits better optical characteristics.

While the lower limit of the thickness of the bonding film 3 is not particularly limited, it is preferably 1 nm or so, and more preferably, 2 nm or so. Thus, the bonding film 3 ensures sufficient adhesiveness.

The wavelength of light passing through the multilayer optical element 5 is not particularly limited and is, for example, 300 to 1200 nm. Since energy provided by light having a wavelength as described above is not too high, alteration or degradation of the bonding film 3 due to application of such light over a long period of time is prevented.

The bonding film 3 has heretofore been described in detail. The above-mentioned bonding film 3 is manufactured using plasma polymerization. By using plasma polymerization, a precise, homogeneous bonding film 3 is efficiently manufactured. Thus, the bonding film 3 is bonded to the second optical component 4 particularly strongly. Also, if the bonding film 3 manufactured using plasma polymerization receives energy and is thus activated, the activated state will be maintained over a relatively long period of time. Thus, the process of manufacturing the multilayer optical element 5 is made simple and efficient.

Hereafter, a method for manufacturing the bonding film 3 will be described.

Before describing the method for manufacturing the bonding film 3, a plasma polymerization apparatus used when manufacturing the bonding film 3 on the first optical component 2 using plasma polymerization will be described.

FIG. 5 is a longitudinal sectional view schematically showing a plasma polymerization apparatus for use in an optical element manufacturing method according to this embodiment. In the following description, the upper side of FIG. 5 will be referred to as “upper” and the lower side thereof will be referred to as “lower.”

A plasma polymerization apparatus 100 shown in FIG. 5 includes a chamber 101, a first electrode 130 supporting the first optical component 2, a second electrode 140, a power supply circuit 180 that applies a high-frequency voltage between the electrodes 130 and 140, a gas supply unit 190 that supplies a gas into the chamber 101, and an exhaust pump 170 that exhausts a gas from the chamber 101. Among these elements, the first electrode 130 and second electrode 140 are provided inside the chamber 101. Hereafter, the elements will be described in detail.

The chamber 101 is a container that can retain air-tightness of the interior thereof, and is used with the interior placed under reduced pressure (vacuum). Therefore, the chamber 101 has a pressure-resistance capability with which it can withstand the pressure difference between the interior and exterior.

The chamber 101 shown in FIG. 5 includes a chamber body whose axis is disposed along the horizontal direction and that takes the shape of a rough cylinder, a circular sidewall that seals a left opening of the chamber body, and a circular sidewall that seals a right opening thereof.

An inlet 103 is made on an upper portion of the chamber 101, and an exhaust port 104 is made on a lower portion thereof. The gas supply unit 190 is connected to the inlet 103, and the exhaust pump 170 is connected to the exhaust port 104.

In this embodiment, the chamber 101 is made of a metal material having high conductivity and is grounded via a ground line 102.

The first electrode 130 takes the shape of a plate and supports the first optical component 2.

The first electrode 130 is provided on the inner wall surface of the sidewall of the chamber 101 along the vertical direction. Thus, the first electrode 130 is grounded via the chamber 101. As shown in FIG. 5, the first electrode 130 is provided concentrically with the chamber body.

An electrostatic chuck (suction mechanism) 139 is provided on a surface supporting the first optical component 2, of the first electrode 130.

As shown in FIG. 5, the first optical component 2 is supported by the electrostatic chuck 139 along the vertical direction. Even if the first optical component 2 has warpage thereon, it can be subjected to plasma treatment in a state where the warpage is corrected by causing the electrostatic chuck 139 to apply a vacuum to and thereby hold the first optical component 2.

The second electrode 140 is provided opposite the first electrode 130 with the first optical component 2 therebetween. The second electrode 140 is provided separated (insulated) from the inner wall surface of the sidewall of the chamber 101.

A high-frequency power supply 182 is coupled to the second electrode 140 via a wiring line 184. A matching box 183 is provided at a midpoint of the wiring line 184. The wiring line 184, high-frequency power supply 182, and matching box 183 constitute the power supply circuit 180.

Since the first electrode 130 is grounded, a high-frequency voltage is applied between the first electrode 130 and second electrode 140 by the power supply circuit 180. Thus, an electric field that has a high frequency and inverts the direction thereof is induced in the gap between the first electrode 130 and second electrode 140.

The gas supply unit 190 is a unit that supplies a predetermined gas into the chamber 101.

The gas supply unit 190 shown in FIG. 5 includes a reservoir 191 that stores a liquid film material (raw liquid), a vaporizer 192 that vaporizes the liquid film material into a gas, and a gas cylinder 193 that stores a carrier gas. These elements and the inlet 103 of the chamber 101 are connected to one another via piping 194, and a mixed gas of the gaseous film material (source gas) and the carrier gas is supplied into the chamber 101 via the inlet 103.

The liquid film material stored in the reservoir 191 is a raw material that is to be polymerized by the plasma polymerization apparatus 100 and then used to form a polymerization film on a surface of the first optical component 2.

Such a liquid film material is vaporized into a gaseous film material (source gas) by the vaporizer 192 and then supplied into the chamber 101. The source gas will be described in detail later.

The carrier gas stored in the gas cylinder 193 is a gas that charges due to an electric field and maintains the charge. Among examples of such a carrier gas are an Ar gas and a He gas.

A diffusion plate 195 is provided near the inlet 103 inside the chamber 101.

The diffusion plate 195 has a function of promoting the diffusion of the mixed gas supplied into the chamber 101. Thus, the mixed gas is diffused inside the chamber 101 in an approximately uniform concentration.

The exhaust pump 170 is a pump that exhausts the chamber 101. For example, an oil-sealed rotary vacuum pump, a turbo-molecular pump, or the like is used as the exhaust pump 170. By exhausting the chamber 101 to decompress it, the gas is easily converted into plasma. Also, use of the exhaust pump 170 prevents contamination, oxidation, or the like of the first optical component 2 due to contact of the first optical component 2 with an ambient atmosphere, as well as effectively eliminates a reaction product produced due to the plasma treatment from the chamber 101.

A pressure control mechanism 171 that controls the pressure inside the chamber 101 is provided on the exhaust port 104. Thus, the pressure inside the chamber 101 is set as appropriate in accordance with the operating state of the gas supply unit 190.

Next, a method for manufacturing the bonding film 3 on the first optical component 2 using the plasma polymerization apparatus 100 will be described.

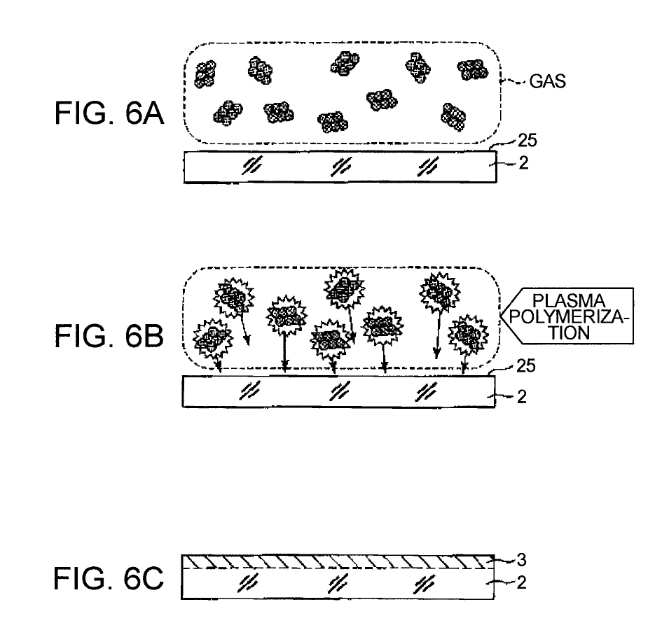

FIGS. 6A to 6C are drawings (longitudinal sectional views) showing the method for manufacturing the bonding film 3 on the first optical component 2. In the following description, the upper side of FIG. 6 will be referred to as “upper” and the lower side thereof will be referred to as “lower.”

The bonding film 3 is obtained by supplying a mixed gas containing a source gas and a carrier gas into a strong electric field so as to polymerize molecules in the source gas and then depositing the resultant polymer on the first optical component 2. Details will be described below.

First, the first optical component 2 is prepared. If necessary, the above-mentioned surface treatment is performed on an upper surface 25 of the first optical component 2.

Next, the first optical component 2 is housed in the chamber 101 of the plasma polymerization apparatus 100 and then the chamber 101 is sealed. Subsequently, the chamber 101 is decompressed by activating the exhaust pump 170.

Next, by activating the gas supply unit 190, a mixed gas containing a source gas and a carrier gas is supplied into the chamber 101. The chamber 101 is impregnated with the supplied mixed gas (see FIG. 6A).

The percentage (mixture ratio) of source gas content of the mixed gas is preferably set to 20 to 70% or so, and more preferably, 30 to 60%, although it slightly varies depending on the types of the source gas and carrier gas, the intended film-making speed, or the like. Thus, the conditions for forming a polymeric film can be tailored as desired.

The flow rates of gases to be supplied are set as appropriate on the basis of the type of the gas, the intended film-making speed, the film thickness, or the like and are not particularly limited. Typically, the flow rates of the source gas and carrier gas are preferably set to 1 to 100 ccm or so, and more preferably, 10 to 60 ccm or so.

Next, the power supply circuit 180 is activated to apply a high-frequency voltage between the pair of electrodes 130 and 140. Thus, molecules of the gas existing between the pair of electrodes 130 and 140 are ionized so that plasma is generated. Molecules of the source gas are polymerized by the energy of the plasma and, as shown in FIG. 6B, the resultant polymers adhere to the first optical component 2 and deposit thereon. Thus, the bonding film 3 formed of the plasma-polymerized film is formed on the first optical component 2 (see FIG. 6C).

Also, the surface of the first optical component 2 is activated and cleaned due to an effect of the plasma. This makes it easy for the polymers formed of the source gas to deposit on the surface of the first optical component 2. Thus, the bonding film 3 is stably formed. As seen, by using plasma polymerization, the bonding strength between the first optical component 2 and bonding film 3 is increased regardless of the material of the first optical component 2.

Among examples of the source gas are organosiloxanes, such as methylsiloxane, octamethyltrisiloxane, decamethyltetrasiloxane, decamethylcyclopentasiloxane, octamethylcyclotetrasiloxane, and methylphenylsiloxane.

The plasma-polymerized film obtained using the source gas, that is, the bonding film 3, is a polymer obtained by polymerizing any one of the above-mentioned materials, that is, a polyorganosiloxane.

While the high frequency to be applied between the pair of electrodes 130 and 140 when performing plasma polymerization is not particularly limited, it is preferably 1 kHz to 100 MHz or so, and more preferably, 10 to 60 MHz or so.

While the power density of the high frequency is not particularly limited, it is preferably 0.01 to 100 W/cm² or so, more preferably, 0.1 to 50 W/cm², and even more preferably, 1 to 40 W/cm². By setting the power density of the high frequency within the above-mentioned range, the application of too much plasma energy to the source gas due to too high a power density of the high frequency is prevented, and the Si skeleton 301 having a random atomic structure is reliably formed. Specifically, if the power density of the high frequency falls below the above-mentioned lower limit, molecules of the source gas may not make polymerization reactions and thus the bonding film 3 may not be formed. On the other hand, if the power density of the high frequency exceeds the above-mentioned upper limit, for example, the source gas may decompose and thus structures that can become leaving groups 303 may be separated from the Si skeleton 301. This may reduce the percentage of leaving group 303 in the obtained bonding film 3 or reduce the randomness (increase the regularity) of the Si skeleton 301.

The pressure inside the chamber 101 during film formation is preferably 133.3×10⁻⁵ to 1333 Pa (1×10⁻⁵ to 10 Torr) or so, and more preferably, 133.3×10⁻⁴ to 133.3 Pa (1×10⁻⁴ to 1 Torr) or so.

The flow rate of the source gas is preferably 0.5 to 200 sccm or so, and more preferably, 1 to 100 sccm or so. On the other hand, the flow rate of the carrier gas is preferably 5 to 750 sccm or so, and more preferably, 10 to 500 sccm or so.

The treatment time is preferably 1 to 10 minutes or so, and more preferably, 4 to 7 minutes or so.

The temperature of the first optical component 2 is preferably 25° C. or more, and more preferably, 25 to 100° C. or so.

In the above-mentioned way, the bonding film 3 is obtained.

### Second Embodiment

Next, a second embodiment of the optical element manufacturing method will be described.

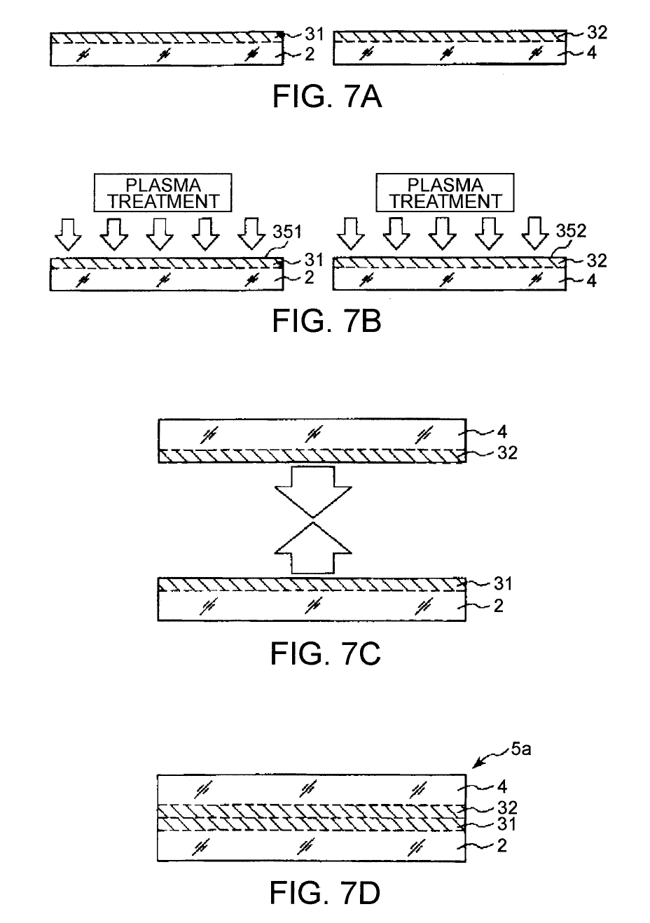

FIGS. 7A to 7D are drawings (longitudinal sectional views) showing the second embodiment of the optical element manufacturing method. In the following description, the upper side of FIG. 7 will be referred to as “upper” and the lower side thereof will be referred to as “lower.”

While the optical element manufacturing method according to the second embodiment will be described hereafter, the difference between the second embodiment and first embodiment will be focused on and duplicate matters will not be described.

In the optical element manufacturing method according to this embodiment, a bonding film is on each surface of the optical components 2 and 4 so that the sum of the thicknesses of the bonding films is equal to or less than the wavelength of light, and the optical components 2 and 4 are bonded together in such a manner that the bonding films are brought into close contact with each other. As for the other matters, this embodiment is the same as the first embodiment.

Specifically, the optical element manufacturing method according to this embodiment includes the step of preparing the first optical component 2 and second optical component 4 and forming a bonding film 31 on a surface of the first optical component 2 using plasma polymerization and also (an preferably simultaneously) forming a bonding film 32 on a surface of the second optical component 4, the step of applying energy to the bonding films 31 and 32, and the step of obtaining a multilayer optical element 5a by bonding together the first optical component 2 and second optical component 4 in such a manner that the bonding films 31 and 32 are brought into close contact with each other. Hereafter, the steps of the optical element manufacturing method according to this embodiment will be described in turn.

1. First, as with the above-mentioned first embodiment, the first optical component 2 and second optical component 4 are prepared. Then, the bonding films 31 and 32 are made on surfaces of the optical components 2 and 4 using plasma polymerization (see FIG. 7A).

The bonding films 31 and 32 are made so that the sum of the thicknesses of these bonding films is equal to or less than the wavelength of light passing through the multilayer optical element 5a. Thus, in the multilayer optical element 5a, the optical influence of the bonding films 31 and 32 upon the passing light is almost negligible. Specifically, even discoloration of the bonding films 31 and 32 or differences in refractive index between the optical components 2 and 4 and bonding films 31 and 32 are prevented from affecting light passing through the multilayer optical element 5a. As a result, light loss or the like caused by the bonding films 31 and 32 is restrained and the finally obtained multilayer optical element 5a exhibits good optical characteristics.

2. Next, as shown in FIG. 7B, energy is applied to the bonding films 31 and 32.

At that time, the leaving groups 303 are eliminated from the Si skeleton 301 at the surfaces of the bonding films 31 and 32. After the leaving groups 303 are eliminated, active hands are formed on the bonding films 31 and 32. Thus, the bonding films 31 and 32 exhibit stable adhesiveness to the first optical component 2 and second optical component 4, respectively. As a result, the bonding films 31 and 32 are stably and strongly bonded to the first optical component 2 and second optical component 4 on the basis of chemical bonds.

3. Next, as shown in FIG. 7C, the first optical component 2 and second optical component 4 are bonded together in such a manner that the bonding films 31 and 32 exhibiting adhesiveness are brought into close contact with each other. Thus, the multilayer optical element 5a as shown in FIG. 7D is obtained.

In this step, the bonding films 31 and 32 are bonded together. This bonding is made on the basis of at least one of the following two mechanisms (i) and (ii).

(i) As an example, a case where hydroxyl groups are exposed on surfaces 351 and 352 of the bonding films 31 and 32, respectively, will be described. When the first optical component 2 and second optical component 4 are bonded together in this step in such a manner that the bonding films 31 and 32 are brought into close contact with each other, the hydroxyl groups existing at the surface 351 of the bonding film 31 and those existing at the surface 352 of the bonding film 32 attract each other on the basis of hydrogen bonds and thus attractive forces occur between these hydroxyl groups. Supposedly, these attractive forces bond the first optical component 2 and second optical component 4 together.

Also, the hydroxyl groups attracting each other on the basis of the hydrogen bonds are dehydrated and condensed depending on the conditions, such as the temperature. As a result, between the bonding films 31 and 32, bonded hands to which the hydroxyl groups are bonded are bonded to each other with an oxygen atom therebetween. Due to the bonding between the bonded hands, the first optical component 2 and second optical component 4 are bonded together more strongly.

(ii) When bonding together the first optical component 2 and second optical component 4 in such a manner that the bonding films 31 and 32 are brought into close contact with each other, unterminated, bonded hands (unbonded hands) formed at the surfaces 351 and 352 of the bonding films 31 and 32 and inside the bonding films 31 and 32 are bonded to each other again. These re-bonds are made in a complicated manner so that the re-bonds overlap each other (intertwine with each other), so a networked bond is formed on the bonding interface. Thus, the base materials (Si skeletons 301) of the bonding films 31 and 32 are directly bonded together so that the bonding films 31 and 32 are combined.

On the basis of the above-mentioned (i) or (ii) mechanism, the multilayer optical element 5a (optical element according to this embodiment) as shown in FIG. 7D is obtained.

While a case where the two layers, that is, the bonding films 31 and 32 are provided between the first optical component 2 and second optical component 4 has been described in this embodiment, three or more layers of bonding films may be provided. Also in this case, the sum of the average thicknesses of the bonding films is desirably equal to or less than the wavelength of light passing through the multilayer optical element 5a.

The optical element manufacturing methods according to the above-mentioned embodiments can be used when bonding various multiple optical components together.

Among examples of optical components to be bonded together are optical lenses, diffraction gratings, optical filters, and protective plates as well as photoelectric conversion elements, such as solar cells, optical recording media, such as optical disks, and display elements, such as liquid crystal display elements, organic electroluminescence elements, and electrophoresis display elements.

Optical Element

Hereafter, a case where the optical element is applied to a wave plate will be described.

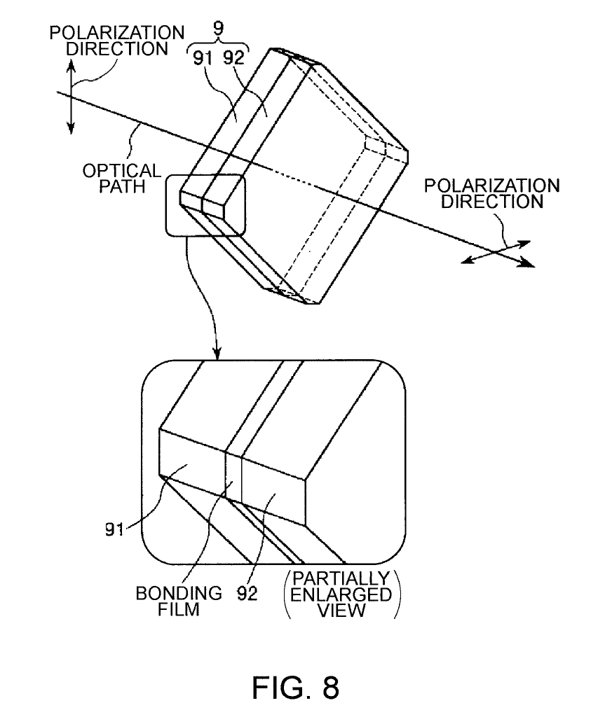

FIG. 8 is a perspective view showing a wave plate (optical element) obtained by applying the optical element.

A wave plate 9 shown in FIG. 8 is a “half-wave plate” that provides a phase difference corresponding to a half-wavelength to light passing through the wave plate. The wave plate 9 is formed by bonding together crystalline plates 91 and 92 having birefringence in such a manner that the optical axes thereof are perpendicular to each other. Among examples of a birefringent material are inorganic materials, such as quartz crystal, calcite, MgF₂, YVO₄, TiO₂, LiNbO₃, and organic materials, such as polycarbonate.

When light passes through the above-mentioned wave plate 9, the light is split into a polarized component parallel with the optical axis and a polarized component perpendicular thereto. Then, one of the split light beams is delayed on the basis of a difference in refractive index due to the birefringence of the crystalline plates 91 and 92. Thus, the above-mentioned phase difference is made.

Incidentally, the accuracy of the phase difference provided to the passing light by the wave plate 9 or the transmittance of the wave plate 9 depends on the accuracy of the thicknesses of the crystalline plates 91 and 92. Therefore, the thicknesses of the crystalline plates 91 and 92 must be controlled with high accuracy.

Moreover, the gap between the crystalline plate 91 and crystalline plate 92 also has an influence upon the phase of the passing light, so the separation distance between the se crystalline plates must be exactly controlled, and these crystalline plates must be bonded together strongly so that the separation distance is not changed.

For this reason, the optical element is applied to the wave plate 9. Thus, the wave plate 9 where the crystalline plate 91 and crystalline plate 92 are strongly bonded together with a bonding film therebetween is obtained.

Also, this bonding film can be made over a wide area at one time using plasma polymerization, which is one of vapor deposition methods. Therefore, the film can be made uniformly and the accuracy of the thickness thereof is high. Therefore, the wave plate 9 where the parallelism between the crystalline plate 91 and crystalline plate 92 is high and various aberrations, such as a wave aberration, are small is obtained.

Also, the bonding film is extremely thin, since the thickness thereof is equal to or less than the wavelength of light passing through the wave plate 9. Therefore, the influence of the bonding film upon the light passing through the wave plate 9 is restrained.

As the wave plate 9, a quarter-wave plate, a ⅛ wave plate, or the like may be used instead of the half-wave plate.

Among optical elements are wave plates as well as optical filters such as polarizing filters, compound lenses, such as optical pick-ups, prisms, and diffraction gratings.

While the optical element manufacturing methods according to the embodiments and the optical element have been described with reference to the drawings, the invention is not limited thereto.

For example, the optical element manufacturing methods according to the embodiments may be combined.

Also, one or more steps having any purpose may be added to the optical element manufacturing methods according to the embodiments as necessary.

While the two optical components, that is, the first optical component and second optical component are bonded together in the optical element manufacturing method according to the embodiments, the optical element manufacturing methods according to the embodiments may be used in the process of bonding three or more optical components together.

Also, the optical elements according to the above-mentioned embodiments are optical elements where the two optical components both have a light transmission characteristic, but not limited thereto. An optical element may be an optical element where only one optical component has a light transmission characteristic and where light is reflected off the bonding interface between the other optical component and a bonding film.

While the bonding film is made on the entire surface of each optical component in the above-mentioned embodiments, the bonding film may be formed on only a part of the surface. In this case, by adjusting the bonding area as appropriate, the concentration of stress on the bonding interface can be reduced. This can prevent problems, such as deformation of the optical element or peeling-off of the bonding interface. Also, since a gap is made between the two optical components, the optical components can be forcibly cooled down, for example, by passing a gas, such as air, through the gap.

While energy is applied to the entire surface of the bonding film and thus the entire surface exhibits adhesiveness in the above-mentioned embodiments, only a part of the surface may exhibit adhesiveness. Also in this case, by adjusting the bonding area as appropriate, the concentration of stress on the bonding interface can be reduced. This can prevent problems, such as deformation of the optical element or peeling-off of the bonding interface.

### WORKING EXAMPLES

Next, specific working examples will be described.

1. Manufacture of Multilayer Optical Element

In each of the working examples, a reference example, and a comparative example, multiple multilayer optical elements were manufactured.

### Working Example 1

First, as the first optical component, a crystal substrate of 20 mm (length)×20 mm (width)×2 mm (average thickness) was prepared. As the second optical component, a crystal substrate of 20 mm (length)×20 mm (width)×1 mm (average thickness) was prepared. These crystal substrates had undergone optical polishing.

Next, these substrates were housed in the chamber 101 of the plasma polymerization apparatus 100 shown in FIG. 5 and then subjected to surface treatment using oxygen plasma.

Next, a plasma-polymerized film having an average thickness of 150 nm was made on each of the surfaces subjected to the surface treatment. The film-making conditions were as follows.

Film-Making Conditions
Composition of source gas: octamethyltrisiloxane
Flow rate of source gas: 50 sccm
Composition of carrier gas: argon
Flow rate of carrier gas: 100 sccm
Output of high-frequency power: 100 W
Power density of high frequency: 25 W/cm²
Pressure inside chamber: 1 Pa (low vacuum)
Treatment time: 15 minutes
Substrate temperature: 20° C.

Under the above-mentioned conditions, plasma-polymerized films were made on the substrates.

The plasma-polymerized films made in the above-mentioned way are each made up of polymers formed of octamethyltrisiloxane (source gas) and each include a Si skeleton including siloxane bonds and having a random atomic structure, and alkyl groups (leaving groups). Also, the degree of crystallization of each plasma-polymerized film was measured using the infrared absorption method. As a result, the degree of crystallization of each plasma-polymerized film was 30% or less, although it slightly varied depending on the measured positions. Next, the obtained plasma-polymerized films were subjected to plasma treatment under the following conditions.

### Plasma Treatment Conditions

Method of plasma treatment: direct plasma method
Composition of treatment gas: helium gas
Ambient pressure: atmospheric pressure (100 kPa)
Distance between electrodes: 1 mm
Application voltage: 1 kVp-p
Voltage frequency: 40 MHz

Next, one minute after the plasma treatment was performed, the substrates were stacked so that the plasma-polymerized films are brought into contact with each other. Thus, multilayer optical elements were obtained.

### Working Example 2

In a working example 2, multilayer optical elements were obtained in the same way as the working example 1 except that a plasma-polymerized film was made on only one of two crystal substrates and no plasma-polymerized film was made on the other crystal substrate.

### Working Example 3

In a third working example, multilayer optical elements were obtained in the same way as the working example 1 except that ultraviolet rays were applied to bonding films under the following conditions rather than performing plasma treatment.

Ultraviolet Ray Application Conditions
Composition of atmosphere: nitrogen atmosphere (dew point: −20° C.)
Temperature of atmosphere: 20° C.
Pressure of atmosphere: atmospheric pressure (100 kPa)
Wavelength of ultraviolet rays: 172 nm

### Reference Example

In a reference example, multilayer optical elements were obtained in the same way as the working example 1 except that the average thickness of each bonding film was set to 300 nm and the sum of the thicknesses of the bonding films was set to 600 nm.

### Comparative Example

In a comparative example, multilayer optical elements were obtained in the same way as the above-mentioned working examples except that the first optical component and second optical component were bonded together using an epoxy optical adhesive (average thickness 3 μm).

2. Evaluation of Multilayer Optical Elements

2.1 Evaluation of bonding strength (cleavage strength)

The bonding strength was measured with respect to each of the multilayer optical elements obtained in the working examples, reference example, and comparative example.

The bonding strength was obtained by measuring the strength immediately before peeling off each substrate. Also, the bonding strength was measured immediately after bonding and was again measured after a temperature cycle of −40 to 125° C. was repeated 100 times after the bonding.

As a result, for the multilayer optical elements obtained in the working examples and reference example, the bonding strength measured immediately after the bonding and that measured after the temperature cycles were both sufficient bonding strength.

On the other hand, for the multilayer optical elements obtained in the comparative example, the bonding strength measured immediately after the bonding was sufficient; however, the bonding strength was reduced after the temperature cycles.

2.2 Evaluation of Dimensional Accuracy

The dimensional accuracy (parallelism) in the thickness direction was measured with respect to each of the multilayer optical elements obtained in the working examples, reference example, and comparative example.

Specifically, the thicknesses of the four corners of each multilayer optical element were measured using a micro-gauge. Subsequently, on the basis of the differences among the thicknesses of the four corners, the relative inclination of both surfaces of each multilayer optical element was calculated.

As a result, for the multilayer optical elements obtained in the working examples and reference example, the parallelism was ±1 second or less. Further, unevenness in parallelism was small among the multiple multilayer optical elements obtained in each of the working example and reference example.

On the other hand, for the multilayer optical elements obtained in the comparative example, the parallelism was ±1 second or more and there was large unevenness in parallelism among the multiple multilayer optical elements.

2.3 Evaluation of Light Transmittance

The light transmittance (wavelength 405 nm) in the thickness direction was measured with respect to each of the multilayer optical elements obtained in the working examples, reference example, and comparative example. The light transmittance was measured after light having a wavelength of 405 nm and an output of 100 mW was continuously applied under a 70° C. environment for 1000 hours. The measured light transmittances were evaluated on the basis of the following evaluation criteria.

Light Transmittance Evaluation Criteria

A: light transmittance is 99.5% or more

B: light transmittance is 99.0% or more and less than 99.5%

C: light transmittance is 98.0% or more and less than 99.0%

D: light transmittance is less than 98.0%

Table 1 exhibits the evaluation result of the light transmittances.

TABLE 1

| | Optical element manufacturing method | | | | |
|---|---|---|---|---|---|
| | bonding film | | | Evaluation result | |
| | | Film | Energy | Light | |
| | | thickness | application | transmittance | |
| | Type | (nm) | method | (λ: 405 nm) | Appearance |
| Working | Plasma-polymerized | 150 + 150 | Plasma | A | A |
| example 1 | film | | | | |
| Working | | 150 | Plasma | A | A |
| example 2 | | | | | |
| Working | | 150 + 150 | UV | A | A |
| example 3 | | | | | |
| Reference | Plasma-polymerized | 300 + 300 | Plasma | B | A |
| Example | film | | | | |
| Comparative | Epoxy adhesive | 3000 | — | D | D |
| Example | | | | | |

As is apparent from Table 1, for the multilayer optical elements obtained in the working examples and reference example, the light transmittance was 99% or more. That is, these multilayer optical elements each exhibited a good light transmission characteristic. On the other hand, the multilayer optical elements obtained in the comparative example exhibited a sufficient light transmission characteristic immediately after these multilayer optical elements started to transmit light; however, the light transmittance fell below 98% after a lapse of 1000 hours, that is, the light transmission characteristic was degraded.

2.4 Evaluation of Appearance

After the light transmittances were evaluated at section 2.3, the appearance of the bonding interface was evaluated with respect to each of the multilayer optical elements obtained in the working examples, reference example, and comparative example on the basis of the following evaluation criteria.

Appearance Evaluation Criteria

A: no discolored areas or bubbles are recognized on the bonding interface

B: a few discolored dots or bubbles are recognized on the bonding interface

C: many discolored dots or bubbles are recognized on the bonding interface

D: many discolored layers or bubbles are recognized on the bonding interface

The evaluation result of the appearance is shown in Table 1.

As is apparent from Table 1, for the multilayer optical elements obtained in the working examples and reference example, no discolored areas or bubbles were recognized on the bonding interface. On the other hand, for the multilayer optical elements obtained in the comparative example, a discolored area was recognized on a portion of the bonding interface corresponding to the optical path after the evaluations were made at section 2.3.

What is claimed is:

1. An optical element, comprising:
first and second optical components, at least one of the first and second optical components having a light transmission characteristic; and
a bonding film bonding together the first and the second optical components, the bonding film being plasma polymerized and including an Si skeleton having a random atomic structure including a siloxane (Si—O) bond and leaving groups binding to the Si skeleton,
wherein the bonding film has leaving groups eliminated from the Si skeleton at a surface of the bonding film, and an average thickness of the bonding film is equal to or less than a wavelength of light passing through the at least one optical component having the light transmission characteristic.

2. The optical element according to claim 1, wherein, in all atoms except for H atoms included in the bonding film, a sum of Si atoms and O atoms ranges from 10 to 90 atom percent.

3. The optical element according to claim 1, wherein a ratio of the Si atoms and the O atoms in the bonding film ranges from 3:7 to 7:3.

4. The optical element according to claim 1, wherein a degree of crystallization of the Si skeleton is equal to or less than 45 percent.

5. The optical element according to claim 1, wherein the bonding film includes an Si—H bond.

6. The optical element according to claim 5, wherein when a peak intensity of the siloxane bond is set to 1 in an infrared absorption spectrum of the bonding film including the Si—H bond, a peak intensity of the Si—H bond ranges from 0.001 to 0.2.

7. The optical element according to claim 1, wherein the leaving groups include at least one of an H atom, a B atom, a C atom, an N atom, an O atom, a P atom, an S atom, a halogen atom, and an atom group in which each of the atoms is arranged so as to bind to the Si skeleton.

8. The optical element according to claim 7, wherein the leaving groups are alkyl groups.

9. The optical element according to claim 8, wherein when a peak intensity of the siloxane bond is set to 1 in the infrared absorption spectrum of the bonding film including methyl groups as the leaving groups, a peak intensity of the methyl group ranges from 0.05 to 0.45.

10. The optical element according to claim 1, wherein the bonding film includes an active bond at a portion where the leaving groups at least around the surface of the bonding film are eliminated from the Si skeleton.

11. The optical element according to claim 10, wherein the active bond is a dangling bond or a hydroxyl group.

12. The optical element according to claim 1, wherein the bonding film is mainly made of polyorganosiloxane.

13. The optical element according to claim 12, wherein the polyorganosiloxane predominantly contains a polymer of octamethyltrisiloxane.

14. The optical element according to claim 1, wherein the average thickness of the bonding film is 90% or less of the wavelength of the light passing through the at least one optical component having the light transmission characteristic.

15. The optical element according to claim 1, wherein the bonding film is a solid having no fluidity.

16. The optical element according to claim 1, wherein the refractive index of the bonding film is 1.35 to 1.6.

17. The optical element according to claim 1, wherein the leaving groups are eliminated by energy application including at least one of application of an energy ray to the bonding film and exposure of the bonding film to plasma.

18. The optical element according to claim 1, wherein the first and the second optical components are made of quartz glass or quartz crystal.

19. The optical element according to claim 1, wherein the wavelength of the light passing through the at least one optical component having the light transmission characteristic is 300 to 1200 nm.

20. The optical element according to claim 1, wherein the bonding film comprises two or more layers between the first and second optical components, and a sum of thicknesses of the layers is equal to or less than the wavelength of the light passing through the at least one optical component having the light transmission characteristic.

21. An optical element manufacturing method, comprising:
(a) preparing a first optical component and a second optical component, at least one of the first and second optical components having a light transmission characteristic and being adapted to be bonded to the other optical component via a bonding film to form the optical element and forming the bonding film on a surface of the first optical component by plasma polymerization, the bonding film including an Si skeleton having a random atomic structure including a siloxane (Si—O) bond and a leaving group binding to the Si skeleton;
(b) applying energy to the bonding film to eliminate the leaving group from the Si skeleton in the bonding film so as to provide adhesive properties; and
(c) bonding together the first and the second optical components via the bonding film to obtain the optical element,
wherein, in step (a), the bonding film is formed so that an average thickness thereof is equal to or less than a wavelength of light passing through the at least one optical component having the light transmission characteristic.
